(19) United States
(12) Patent Application Publication
(10) Pub. No.: US 2017/0373560 A1
(43) Pub. Date: Dec. 28, 2017

(54) Mechanical Battery

(71) Applicant: Mohamed Sharkas, Mashtul As Suq (EG)

(72) Inventor: Mohamed Sharkas, Mashtul As Suq (EG)

(21) Appl. No.: 15/228,215

(22) Filed: Aug. 4, 2016

(30) Foreign Application Priority Data
Aug. 15, 2014 (EG) 15228215

(51) Int. Cl. H02K 7/18; F03D 9/25; F03D 9/10; F03G 1/02; F03G 1/08

(52) U.S. Cl. CPC H02K 7/1853; F03G 1/02; F03G 1/08; F03D 9/10; F03D 9/25; F03G 2730/01

(57) ABSTRACT

The Mechanical battery stores kinetic energy in the form of Potential Energy then converts it to electrical energy and has five ways to recharged which are the manual method, Manual Automatic method and in association with wind energy as well as the home electricity and solar energy.

What is new in the invention?

It is that the battery stores the kinetic energy in the form of Potential Energy then converts it to electrical energy, as well as the small ones of the same doesn't need chargers and have a long useful life compared to others, it is eco-friendly and also make advantage of both wind and solar energy complete and stable and generates AC or DC generating 1, 2 or 3 phases as needed.

### THE TECHNICAL FIELD

The technical field of the invention is the field of batteries storing electric energy, which is considered the second kind of batteries until now since all other batteries store electricity in the form of chemical energy. Yet, this new battery, subject of the invention, stores electricity in the form of mechanical energy. In some of its forms, it does not need charging, wires or chargers. In other forms, it is charged by wind or solar energy. It is used in the following fields:
1—Cell phones and smart devices in general.
2—Solar energy.
3—Wind energy.
4—Potential energy.

This is detailed in full in the explanation of the invention.

### BACKGROUND ART

Chemical batteries, which were invented previously and are still in use until now, whether dry or liquid, are among the things that developed humans. These batteries have a lifetime not exceeding four years for the good types. Some of them continue for days and months. They depend in their manufacturing on materials harmful to man and the environment in general with lots of machines depending thereon to work, such as cars, phones, headlights . . . etc.

To be charged, they need an electric source, chargers and cables of wires. They need several hours for charging and in maintenance; they need many things. Moreover, they are heavy and if they expire, they are thrown to garbage boxes or in the streets or recycled, which irreversibly harms the environment. Again, pollution with these materials leads to chronic diseases that affect man, animal and even fishes in the sea.

Therefore, the solution is now represented in this new invention that I called “Mechanical Battery”. May God grant us success!

### PROBLEM OR SHORTAGE IN THE BACKGROUND ART

Chemical batteries whether dry or liquid have the following disadvantages:

1—Not long living, they expire in days to four years only.

2—Manufactured of poisonous materials harmful to man and animal.

3—Heavy in weight.

4—Need an electric source for charging which is not available away from electricity.

5—When thrown away, they are harmful to the environment. 6—They need a suitable fit charger and wires for charging.

7—Need a long time to be charged.

### DISCLOSURE OF INVENTION

The new invention, which I called “Mechanical Battery” which is manufactured in four ways or more, is featuring many advantages to make the dream that human dreamed long time ago come true. This is represented in the following:
1—Long fasting for decades with no damage.
2—Not needing chargers or wires to be charged.
3—They do not need electric sources to be charged as they are charged either manually or in conjunction with potential energy or wind power etc.
4—They are not pollutant to the environment.
5—They provide an electrical source at any time anywhere.
6—They solve problems of smart equipments such as mobile phones, electric cars . . . etc.
7—They adjust and utilize wind and solar energy very well.
8—They are used in manufacturing the batteries of satellites and spaceships, which are charged with solar energy that increases its longevity many times more than their current virtual lifetime.
9—These batteries can generate direct and alternating current. They can also generate one or three electric ends with one negative end (3 phases). This depends on the way the dynamo wires are coiled or according to their need to usage.
10—These batteries are used with all machines and equipment beginning with cell phones, ending with spaceships. They provide man with an electric source wherever he goes.

### BRIEF DESCRIPTION OF DRAWINGS

FIG. 1 depicts a first embodiment of a mechanical battery.

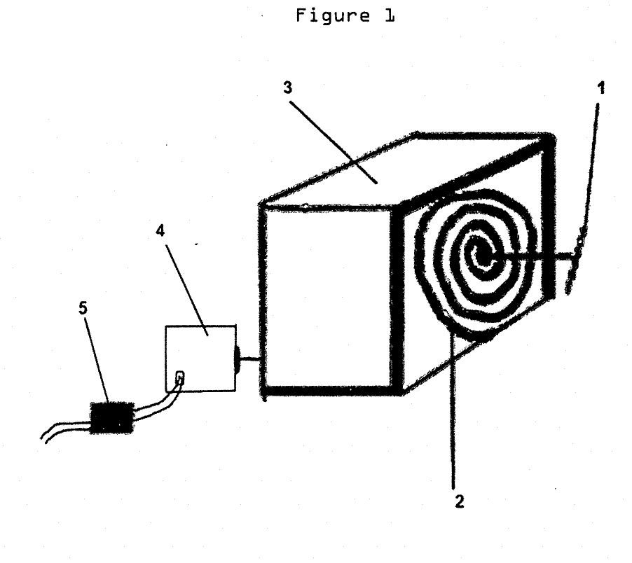

FIG. 2 depicts a second embodiment of a mechanical battery.

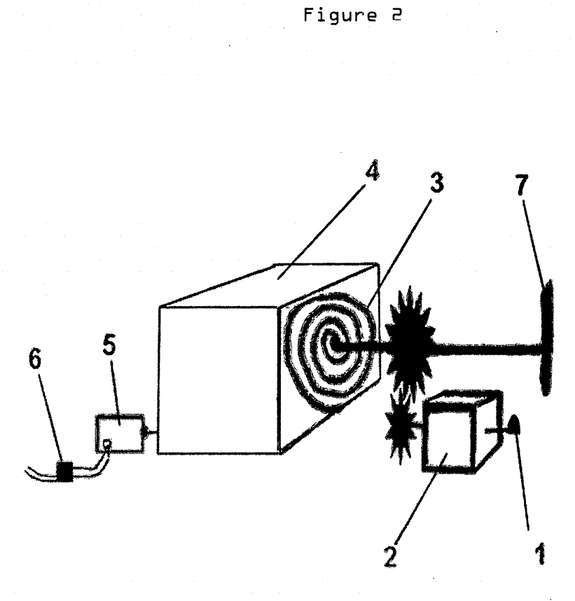

FIG. 3 depicts a third embodiment of a mechanical battery.

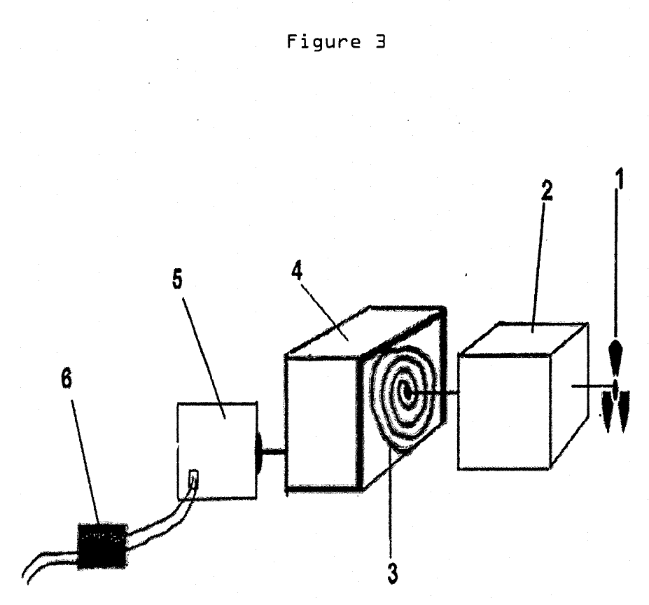

FIG. 4 depicts a fourth embodiment of a mechanical battery.

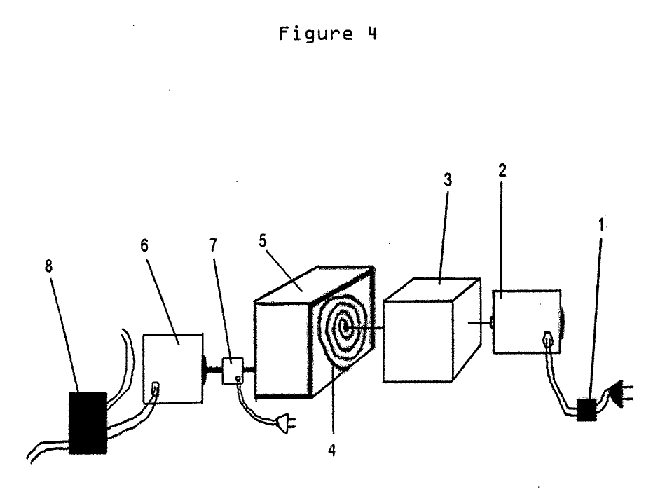

FIG. 5 depicts a fifth embodiment of a mechanical battery.

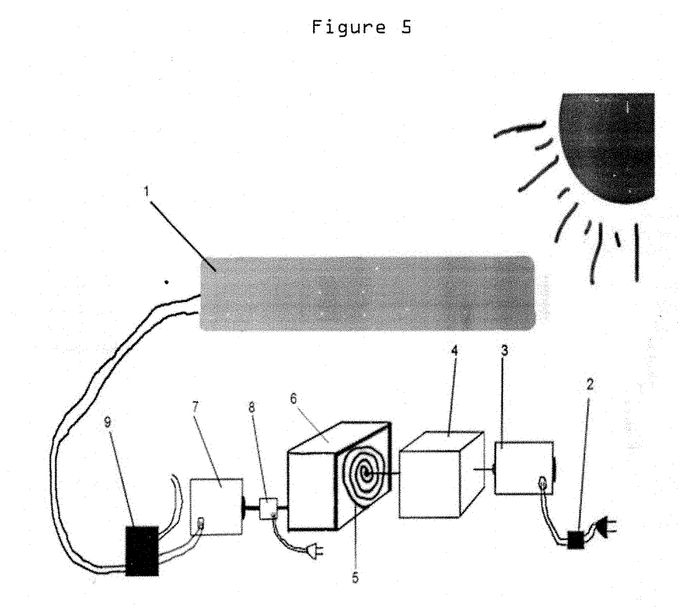

### DETAILED DESCRIPTION

This invention, called the “Mechanic Battery” has four ways or more in its composition and components:

First Technique consists of the following parts: 1—An operating handle.

2—A spring wire.

3—A group of gears for accelerating speed.

4—A suitable electric generator.

5—An electricity unification circuit; when needed.

### Parts Explanation

1—A handle to charge the battery. This handle is connected with the column on which the spring is fixed. It becomes engaged when the battery is charged by pulling the spring a little out. Then, after complete filling, it is being returned to the inside so that it is being separated from the column.

2—A spring wire; taking into account, thickness, strength and length suitable for the machine work. The longer the spring, the longer time the battery works. The thicker the spring, the higher the voltage generated from the battery.

3—A group of gears for increasing speed. The gears should be doubled; i.e. the big gear having a small gear to reduce the volume of the Mechanic Battery and perform their purpose.

The first gear should spin in one direction and the spring should be bearing on the first gear column, so that, when the first gear is turned to fill in the spring, the movement is separated from the other gears connected to the generator. The first or second gear is loaded on a lining or a group of linings, permitting loading thereon and isolating movement from other gears when filling in the spring (like the gear in the back wheel of a bicycle). This is for the simplicity as when filling in the spring in an easy way, not needing high effort.

4—A suitable generator in which the rotor element contains a magnet either natural or artificial having two poles or four at most. This is to adjust the gear speed and not to discharge the spring at once. However, the dynamo shall have two poles magnet in its rotor and two coils at its stator to complete this mission at best.

This mission is performed by the (pendulum) in old days' watches and the mechanic timer.

Moreover, it shall be taken into consideration that the dynamo shall directly be a direct current generator for devices that need alternating current. Both ends of the dynamo shall be directed to the ends of the device, which needs to be fed with electricity. All this shall be adjusted in a suitable way.

5—An electric unification circuit; when needed.

### Operating Technique

The Mechanical Battery is filled in this case that manually through a handle outside, being turned in the direction compressing the spring that turns easily in one direction. Then the handle is entered in the device so that the spring springs back again to move the gears which in turn operates the generator that generates electricity then the alternating current produced by the dynamo turns into a direct current by the unification circuit then the both ends are directed to the device that needs to be fed with electricity,

All being with the power and will of God . . .

### Usages of This Technique

This Technique is used to work cell phones, laptops, computers, headlights etc . . .

The Second Technique consists of following parts:
1—A half or one-third rounded flywheel.
2—A group of gears for reducing speed.
3—A spring.
4—A group of gears for accelerating speed.
5—A suitable generator.
6—A unification circuit; when needed.
7—A handle for manual operating.

### Parts Explanation

1—A half or one-third rounded flywheel fixed on a column that has a small gear fixed thereon to give a bigger gear with a small gear fixed thereon connected to a bigger one and soon.

The column, the flywheel and gear fixed thereon shall work in one direction so as when the flywheel moves up due to battery body movement or any other movement the rises up easily due separating movement from the other gears through a fiber or a metal slice fixed for this purpose.

So, if the flywheel comes back to the resting situation due to earth gravity, the gear fixed to the flywheel column engages to the group of gears connected to the column the spring is fixed on.
2—A group of gears for reducing the speed begins with the gear fixed on the flywheel column and ends with the gear that the spring fixed on its column.
3—A spring, which is considered the backbone of the machine that shall be suitable in length and thickness as, explained before.
4—A group of gears for accelerating the speed begins with a big gear fixed on the spring. This gear works in one direction as if the flywheel moves, it leads to moving this gear to fill in the spring and in the same time. The movement is being separated from other groups of gears related to the generator.
5—A suitable generator with the rotor inside containing a magnet either natural or artificial. It shall have two or four poles at most. This is to adjust the gears' speed and not to discharge the spring at once whereas the dynamo that contains two poles of magnet at its rotor and two poles of the coils in the stator complete this mission at best.

This is the mission the (pendulum) did in watches of the old days and in the mechanical timer. All this shall be adjusted in a suitable way,

6—A unification circuit makes the electric current generated from the dynamo direct instead of being alternating. The two ends of the circuit are being directly directed to the device,

(So the dynamo shall generate a direct current and then the unification circuit is being dispensed).

7—A handle for manual switching. This is when there is no movement or potential energy, the handle is being pulled to the outside, so it is engaged with the column on which the spring is fixed, so the spring contracts and then it is pushed to the inside to be separated from the column of the spring.

### Operating Technique

This technique is considered a manual-automatic so if the devise body moves, the spring is charged by the movement. If there was no movement, the spring is charged manually like the first operating technique. This is through a handle connected to the column on which the spring is fixed.

During filling by hand, the movement shall be isolated from the group of gears that reduce the speed connected to the flywheel. In the same time, the movement is separated from the other group connected to the dynamo. During filling it in by movement, the flywheel simply and easily swings back and forth so that the spring gradually contract then it spreads making the dynamo turn and generate electricity.

### Usages of This Technique

This technique is used with cell phones, electric cars and any mobile device.

### The Third Technique

This works by wind power, consists of the following parts:
1—A fan, or plastic or wood plate to face air, 2—A group of gears for reducing speed.
3—A spring.
4—A group of gears to accelerate speed.
5—A dynamo.
6—A unification circuit (when needed)

### Parts Explanation

1—A wood plate or fan moved by air fixed on a high column. This column has a small gear turning in one direction (i.e. instead of the flywheel in the second technique above).

2—A group of gears for reducing speed starting with the gear fixed on the fan or the plate column. This ends with the gear on which column the spring is fixed.

3—A spring that is considered the spring of the machine. And it shall be suitable in length and thickness as explained before.

4—A group of gears for accelerating speed starting with a big gear in which the spring is fixed. This gear works in one direction. If the plate or fan moves, it ends to moving this gear to fill in the spring and at the same time; the movement is separated from the rest group of gears that are connected to the generator.

A suitable generator. Its roller shall contain a magnet whether natural or artificial and to have two poles or four at most. In addition, this is to adjust the speed of gears and not to discharge the spring at once. Whereas the dynamo that has magnetic two poles at its rotor and on two poles of coils at its stator completes this mission in the best way. This is the mission the (pendulum) did in watches of the old days and in the mechanical timer.

Taking into consideration that the dynamo shall directly be a direct current generator. This is in devices needing direct current. The dynamo shall generate be an alternating current with devices that need alternating current and the ends of the dynamo are directed to the ends of the device that needs electricity.

In addition, the dynamo shall be a generator for three positive ends (3 phases) and this is according to usage needs.

5—A unification circuit that makes the electricity generated from the dynamo a direct current instead of alternating and the ends of the circuit are being directly directed to the device or the machine. (The circuit shall be used when needed).

### Operating Technique

When the plate is moved by the wind, it simply and easily rises up due separating movement from the other gears. So when it is back to the rest position because of earth gravity, the gear is engaged to the column, which leads to connecting the movement with the spring column and through continuous movement by the wind the spring is compressed and so the dynamo works and generates electricity.

However, when the fan moves by the wind, its movement passes through the gears that reduce speed to the spring column and so the column coils to compress the spring.

### Usages of This Technique

This technique is suitable for the fields to run irrigation machines and provide houses with electricity as the wind contracts the spring in the period when electricity is not in use. So, when it is needed when there is no wind, the spring is so filled with charging.

This is considered a new opening in this realm as it can enter the domain of generating electricity by wind power in which the generated energy ranges among lacking, few and plenty according to wind strength and weakness. Therefore, when energy is saved in a strong spring, it becomes practical, continuous and permanent energy. This is due to the existence of power saved for many hours that makes it a perfect energy for human usage.

### The Fourth Technique

It is a mechanical battery filled or charged by an electric motor consisting of the following parts:
1—An overload.
2—A suitable electric motor.
3—A group of gears for reducing the speed.
4—A suitable spring.
5—A group of gears for accelerating the speed.
6—A suitable generator.
7—An electric brake.
8—Relay or cut-out for cutting and connecting electricity automatically.

### Parts Explanation

1—An overload in the junction coming from home electricity going to the electric motor. When filling the spring and being completely charged, its mission is to pull out high electricity which makes the overload cut electricity from the motor.

2—An electric motor that shall be suitable in its power to fill the spring.

3—A group of gears to reduce speed that connected to the motor from an end and to the column that the spring is on from the other end.

4—A spring that is fit in length and strength.

5—Gera group for accelerating speed connected to the motor on one side and to the column with the spring on the other side.

6—A suitable electric generator as explained before. (It can produce one or three phases).

7—An electric brake containing an electric coil so as to press on the column connected to the dynamo to stop it from turning when there is electricity, so that when electricity is cut, it separates from the dynamo column then the dynamo becomes free to move.

8—Relay or cut-out with the following functions:
A. Connects electricity coming from outside the house with the two ends feeding the house. This is when electricity is present.
B. When electricity cuts off, the coil of the relay stops from pulling the chip connecting electricity into the house. In this case, when the chip separates from the coil, it connects electricity coming from the generator and the house is directly fed with electricity.(All this happens in a fraction of a second)

### Operating Technique

The electric motor is connected to the house electricity and existing in the electricity junction connected to the motor. The overload cuts electricity from the motor when the spring is completely charged. So if electricity is connected to the motor, the motor turns the gears which reduce, connected to the column with the spring which so contracts. When it contracts, the motor stops from whirling and the dynamo does not work after the spring is full in presence of the original electricity of the house. That is because of the electric brake that stops it in presence of electric current. So, when it cuts off, the following happens:

The brake is released so the dynamo becomes free and at the same time the spring opens so that the gears and dynamo turn, then electricity is generated.

The relay or the cut-out at the same time disconnect the original electricity ends and connects the dynamo electricity. That is because when the original electricity exists, the relay coil attracts a metal chip that conducts electricity to the house; so that if electricity cuts off, it cuts from the relay coil and the metal chip comes back to its normal position making positive and negative ends coming from the dynamo touch the house electricity wires made for lighting lamps or the house in general when the mechanic battery size is big.

### Usages of This Technique

It can be used with houses, shops, doctors' clinics . . . etc. (when electricity is cut off).

### The fifth Technique

it works in combination with light energy.

It is the same as the fourth technique in components, except that it replaces house electricity with electricity of photoelectric panels (known as light or solar energy) as when there is light the electric motor runs and contracts the spring. At the same time the dynamo does not run because of the electric brake. So, if light stops and it is dark; the relay or cut-out cuts out the electricity ends coming from the solar panels and conducts electricity generated by the dynamo to the house after the electric brake stops. (And all this happens in a fraction of one second).

### Usages of this Technique

1—This technique is used with absolute success with solar energy. This is instead of using mechanic batteries with lots of disadvantages. This leads to reducing the cost of one kilowatt generated by solar energy. Also using this technique with solar energy, the battery is charged very quickly not like the case in mechanical batteries.
2—This technique can be used with absolute success with satellites of short lives because of the mechanical batteries therein.
So, if this technique is used with satellites it shall double its life more and more. All this saves money and energy wasted in manufacturing such satellites.

### Method of Use

1—Cell phones and smart mobile devices in general.
2—Indicator lights and insect zappers
3—Computer sets.
4—Wind power plants.
5—Wireless devices used by police officers and others.
6—Electric cars.
7—Radio and telephone devices.
8—Running watering machines in fields and lighting houses far from electricity sources.
9—It is used in generating electricity to operate satellites and spaceship.
10—It is used in combination with solar energy and wind power.
11—It is used when electricity cuts off from houses, doctor clinics and hospitals.
12—It is used to light lamp posts without need to electricity.

IN conclusion this it is used for everything that needs energy to work.

1. The First Component:
A Mechanic battery consisting of five techniques:
1—Manual technique.
2—Auto-manual technique.
3—In combination with the wind power.
4—The fourth technique that is charged by an electric motor.
5—In combination with solar energy.

2. Second Component:
Mechanical battery in its first state, the manual method consisting of:
A handle connected to a pole with a spring installed on that column. This spring is connected to the beginning of a set of gears that would increase speed. The end of that group is connected to a suitable dynamo with two ends (two wires) coming out in an electronic circuit working to unify electricity into a direct current when needed.

3. Third Component:
Mechanical battery in its second state, the manual method consisting of:
Circular Flywheel with a column connected to a set of gears to reduce speed. The end of that group is connected to a pole on which a spring is installed. The spring is connected to the beginning of group of gears to increase speed. The end of that group is connected to a Dynamo to generate electricity. The dynamo is appropriate and the two ends (two wires) coming out in an electronic circuit working to unify electricity into a direct current. It is used when needed. This method is completely automatic in which the battery is charged through movement or shaking of the battery body to become an automatic handle by addition of a pole connected to a handle connected to the spring pole so that the spring is manually held when there is no movement or shaking of the battery body.

4. Fourth Component:
Mechanical battery in its third state, which is charged by wind power consisting of:
A fan connected to the beginning of a set of gears to reduce speed. The end of the group of gears is connected to a pole on which a spring is installed. The spring is connected to the beginning of group of gears to increase speed. The end of that group is connected to a dynamo to generate electricity. The dynamo is appropriate and the two ends (two wires) coming out in an electronic circuit working to unify electricity into a direct current. It is used when needed.
Or left to repel air by lifting it up and then coming down by gravity. When coming off it couples with a pole, which is the beginning of the transmission range to reduce speed. The end of the gears is connected to a pole on which the spring is installed being connected to the beginning of the transmission range to increase speed. The end of that group is connected to a dynamo to generate electricity. The dynamo is appropriate and the two ends (two wires) coming out in an electronic circuit working to unify electricity into a direct current. It is used when needed.

5. Fifth Component:
Mechanical battery in its fourth state, which is charged by an electric motor consisting of:
An electric cable connected to an open electricity from outside home. The cable is connected to an overload then to a suitable electric motor to hold the spring. The electric motor is connected to the beginning of the transmission range to reduce speed. The end of the group is connected to a pole by an appropriate spring. The spring pole is connected to the beginning of the transmission range to increase speed. The end of the group is connected to an appropriate electric generator. The pole of the electric generator has a brake connected to electricity coming from outside home. The ends coming out of the dynamo are connected to a relay or cut-out where the relay or cut-out replace the electric ends automatically on black out.

6. Sixth Component:
Mechanical battery in its fifth state, charged with solar energy and consisting of:
Photoelectric plates, from which comes out a cable connected to an overload then to a suitable electric motor to hold the spring. The electric motor is connected to the beginning of the transmission range to reduce the speed and the end of the group connected to a pole by the spring and appropriate column spring connected to the beginning of the transmission range to increase speed. The end of the group is connected to an appropriate electric generator with an electric brake connected to electricity coining from the solar panels and the ends (wires) emerging from the dynamo are connected to relay or cut-out where the relay or cur- out replace electric ends automatically on absence of light and interruption of electricity coming from the solar panels.
